(19) United States
(12) Patent Application Publication
(10) Pub. No.: US 2018/0079341 A1
(43) Pub. Date: Mar. 22, 2018

(54) VEHICLE OCCUPANT RESTRAINING DEVICE

(71) Applicant: TOYOTA JIDOSHA KABUSHIKI KAISHA, Toyota-shi (JP)

(72) Inventor: Ritsu NISHIMURA, Nagoya-shi (JP)

(73) Assignee: TOYOTA JIDOSHA KABUSHIKI KAISHA, Toyota-shi (JP)

(21) Appl. No.: 15/672,710

(22) Filed: Aug. 9, 2017

(30) Foreign Application Priority Data
Sep. 21, 2016 (JP) 2016-184408

(51) Int. Cl. B60N 2/68; B60R 22/02; B60R 22/195; B60R 22/20; B60R 22/26

(52) U.S. Cl. CPC B60N 2/688; B60R 22/023; B60R 2022/1818; B60R 22/20; B60R 22/26; B60R 22/195

(57) ABSTRACT

The vehicle occupant restraining device includes: a three-point seatbelt device adapted to restrain a vehicle occupant, who is seated at a vehicle seat, by a shoulder belt portion and a lap belt portion of a seatbelt; a rear side restraining portion configured to be disposed at a seatback of the vehicle seat, and spanning between left and right side frames of the seatback, the rear side restraining portion being in a slack state and convex toward a seat rear side; and a pulling device that, by pulling at least one end portion side of the rear side restraining portion, reduces slack of the rear side restraining portion.

### CROSS-REFERENCE TO RELATED APPLICATION

This application claims priority under 35 USC 119 from Japanese Patent Application. No. 2016-184408 filed Sep. 21, 2016, the disclosure of which is incorporated by reference herein in its entirety.

### BACKGROUND

### Technical Field

Preferred embodiments relate to a vehicle occupant restraining device that restrains a vehicle occupant who is seated in a vehicle seat.

### Related Art

The seatbelt device of a vehicle seat that is disclosed in Japanese Patent Application Laid-Open (JP-A) No. 2015-227149 is structured such that a shoulder webbing (a shoulder belt portion) of a three-point seatbelt is tightened by a retractor at the time of an emergency. In this seatbelt device, a concave portion is formed in the upper portion of the front surface of the seatback at the side of the shoulder of a seated person, and an anchoring means that can anchor the shoulder belt portion is provided in this concave portion. Due thereto, even in a case in which the seated person is of a small physique, the shoulder webbing is tightened instantaneously at the time of an emergency, and the shoulder of the seated person is pushed against the seatback, and the submarine phenomenon is suppressed.

On the other hand, the vehicle occupant protecting device disclosed in JP-A No. 2007-015466 is structured such that, due to an airbag that is provided at a vehicle seat being inflated by an inflator at the time of a collision, the buttocks or the lumbar region of the vehicle occupant is pushed-out toward the lap belt portion of a three-point seatbelt. Due thereto, the reliability of restraining the lumbar region of the vehicle occupant is improved, and the submarine phenomenon is suppressed.

The main object of a general three-point seatbelt is to suppress forward movement of the vehicle occupant at the time of a collision, and the restraining force that suppresses sideways movement of the vehicle occupant is low.

Further, the seatback of a vehicle seat has a side supports for suppressing sideways movement of the vehicle occupant. However, because the rigidity of the portion that contacts the vehicle occupant is low, even if the seatbelt exists at the front of the vehicle occupant, the seatback deforms at the rear and the sides of the vehicle occupant. Therefore, in a case of a form of a collision in which inertial force toward the side is applied to the vehicle occupant such as in a side collision or an asymmetrical collision (an oblique collision or the like), there is a concern that it is easy for the vehicle occupant to move relatively toward the side with respect to the vehicle seat.

With regard to this point, in the seatbelt device disclosed in JP-A No. 2015-227149, a retractor has a tightening mechanism (a pretensioner mechanism) of the shoulder belt portion. However, restraining force that sufficiently pushes the upper half of the body of the vehicle occupant toward the vehicle seat at the time of a collision cannot be obtained by only the pretensioner mechanism. Therefore, it is difficult to suppress sideways movement of the vehicle occupant with respect to the vehicle seat.

On the other hand, as in JP-A No. 2007-015466, in the case of a structure that pushes the buttocks or the lumbar region of the vehicle occupant out toward the lap belt portion side by an airbag, the force of restraining the lower half of the body of the vehicle occupant improves. However, because the lumbar spine (backbone) of the vehicle occupant bends, the force of restraining the region, which is further toward the upper side than the lumbar region, at the upper half of the body of the vehicle occupant does not improve. Further, if the airbag is not supported from the direction opposite the vehicle occupant (from the seat rear side) by a reaction force member that can withstand the inflation pressure of the airbag, the airbag inflates in that opposite direction. Therefore, because a reaction force member such as mentioned above becomes a necessary structural element, there is room for improvement from the standpoint of simplifying the structure.

### SUMMARY

In consideration of the above circumstances, an object of preferred embodiments is to provide a vehicle occupant restraining device that can, by a simple structure, effectively suppress relative movement of the upper half of the body of a vehicle occupant toward the sides with respect to a vehicle seat at the time of a vehicle collision.

A vehicle occupant restraining device of a first aspect of the disclosure includes: a three-point seatbelt device that is adapted to restrain a vehicle occupant, who is seated at a vehicle seat, by a shoulder belt portion and a lap belt portion of a seatbelt; a rear side restraining portion that is configured to be disposed at a seatback of the vehicle seat, and the rear side restraining portion spans between left and right side frames of the seatback, the rear side restraining portion being in a slack state and convex toward a seat rear side; and a pulling device that, by pulling at least one end portion side of the rear side restraining portion, reduces slack of the rear side restraining portion.

In the vehicle occupant restraining device of the first aspect, the vehicle occupant who is seated at the vehicle seat is restrained by the shoulder belt portion and the lap belt portion of the seatbelt of the three-point seatbelt device. The rear side restraining portion is disposed at the seatback of the vehicle scat and is disposed at the seat rear side of the upper half body of the vehicle occupant. This rear side restraining portion spans between the left and right side frames of the seatback in a slack state and convex toward the seat rear side. For example, at a time when a side collision or an asymmetrical collision (an oblique collision or the like) of the vehicle is sensed or predicted, at least one end portion side of the rear side restraining portion is pulled by the pulling device, and the slack is reduced. As a result, the upper half body of the vehicle occupant is nipped and restrained from the front and rear both sides by the rear side restraining portion and the shoulder belt portion. Due thereto, sideways movement of the upper half body of the vehicle occupant with respect to the vehicle seat can be suppressed effectively. Moreover, at the above-described time of restraining the vehicle occupant, reaction force can be imparted to the rear side restraining portion by the left and right side frames between which the rear side restraining portion spans. Therefore, there is no need for a special reaction force member for imparting reaction force to the rear side restraining portion. Due thereto, the structure can be simplified. Note that the aforementioned “reducing” includes cases in which the slack is completely eliminated.

In a vehicle occupant restraining device of a second aspect of the disclosure, in the first aspect, the pulling device is a take-up device that pulls at least the one end portion side of the rear side restraining portion while taking-up at least the one end portion side onto a take-up shaft.

In the vehicle occupant restraining device of the second aspect, as described above, the pulling device is structured by the take-up device that takes-up at least the one end portion side of the rear side restraining portion onto a take-up shaft. Therefore, the space for placement of the pulling device can be reduced as compared with a structure in which at east one end portion side of the rear side restraining portion is pulled rectilinearly.

A vehicle occupant restraining device of a third aspect of the disclosure, in the first aspect or the second aspect, further includes a vehicle seat, wherein the rear side restraining portion is a belt member that is thrilled in an elongated shape and that is disposed at an interior of a seatback of the vehicle seat.

In the vehicle occupant restraining device of the third aspect, the belt member that serves as the rear side restraining portion is disposed at the interior of the seatback, and the belt member cannot be seen from an outer side of the vehicle seat. Therefore, the design of the vehicle seat does not deteriorate.

In a vehicle occupant restraining device of a fourth aspect of the disclosure, in the third aspect, the seatback has a seat pad that includes a pad main body portion that is adapted to support a back portion of the vehicle occupant from the seat rear side, and an intermediate portion of the belt member is disposed at a seat rear side of the pad main body portion.

In the vehicle occupant restraining device of the fourth aspect, the intermediate portion of the belt member is disposed at the seat rear side of the pad main body portion that supports the back portion of the vehicle occupant from the seat rear side. Therefore, the vehicle occupant receiving an uncomfortable sensation from the belt member at usual times can be prevented or effectively suppressed.

In a vehicle occupant restraining device of a fifth aspect of the disclosure, in the third aspect, the seatback has a seat pad that includes a pad main body portion that is adapted to support a back portion of the vehicle occupant from the seat rear side, and an intermediate portion of the belt member is disposed at a seat front side of the pad main body portion.

In the vehicle occupant restraining device of the fifth aspect, the intermediate portion of the belt member is disposed at the seat front side of the pad main body portion. Therefore, the pad main body portion is not interposed between the upper half body of the vehicle occupant and the intermediate portion of the belt member. Due thereto, the restraining force at the time when slack of the belt member is reduced and the upper half body of the vehicle occupant is restrained increases, as compared with a case in which the pad main body portion is interposed between the upper half body of the vehicle occupant and the intermediate portion of the belt member.

In a vehicle occupant restraining device of a sixth aspect of the disclosure, in the third aspect, the seatback has a seat pad that includes a pad main body portion that is adapted to support a back portion of the vehicle occupant from the seat rear side, and an intermediate portion of the belt member is embedded in the pad main body portion.

Because the vehicle occupant restraining device of the sixth aspect is structured as described above, the restraining force at the time when slack of the belt member is reduced and the upper half body of the vehicle occupant is restrained is increased more than in the fourth aspect, and, at the same time, the uncomfortable sensation that the vehicle occupant receives from the belt member at usual times can be reduced more than in the fifth aspect.

In a vehicle occupant restraining device of a seventh aspect of the disclosure, in the third aspect, the seatback has a seat pad that includes a pad main body portion that is adapted to support a back portion of the vehicle occupant from the seat rear side, and a seat surface skin that includes a front surface skin that covers the pad main body portion from a seat front side, and an intermediate portion of the rear side restraining portion is structured by the front surface skin.

In the vehicle occupant restraining device of the seventh aspect, because the intermediate portion of the rear side restraining portion is structured by the front surface skin of the seat surface skin, the structure of the device can be simplified.

In a vehicle occupant restraining device of an eighth aspect of the disclosure, in the third aspect, the belt member is disposed so as to be tilted in a direction opposite to a direction in which direction the shoulder belt portion is disposed as seen in a seat front view.

In the vehicle occupant restraining device of the eighth aspect, the belt member and the shoulder belt portion cross one another in the form of an X as seen in a seat front view. Therefore, the upper half body of the vehicle occupant can be restrained in a well-balanced manner at the left and the right by the belt member and the shoulder belt portion.

As described above, the vehicle occupant restraining devices of the preferred embodiments can, by a simple structure, effectively suppress relative movement of the upper half of the body of a vehicle occupant toward the sides with respect to a vehicle seat at the time of a vehicle collision.

### BRIEF DESCRIPTION OF THE DRAWINGS

Preferred embodiments will be described in detail based on the following figures, wherein:

FIG. 1 is a perspective view showing a vehicle occupant restraining device relating to an embodiment of the present disclosure;

FIG. 2 is an enlarged sectional view showing, in an enlarged manner, the cut cross-section along line F2-F2 of FIG. 1;

FIG. 3 is a cross-sectional view that corresponds to FIG. 2 and shows a state in which slack of a belt member is reduced by a take-up device;

FIG. 4 is a side view showing an example of the take-tip device;

FIG. 5A is a cross-sectional view in which illustration of a seat pad and a seat surface skin is omitted from the structure shown in FIG. 2;

FIG. 5B is a cross-sectional view in which illustration of the seat pad and the seat surface skin is omitted from the structure shown in FIG. 3;

FIG. 6A is a cross-sectional view in which illustration of the seat surface skin is omitted from the structure shown in FIG. 2;

FIG. 6B is a cross-sectional view corresponding to FIG. 6A and showing a modified example in which the belt member is embedded in a pad main body portion;

FIG. 6C is a cross-sectional view corresponding to FIG. 6A and showing a modified example in which the belt member is disposed at a seat front side of the pad main body portion;

FIG. 7 is a cross-sectional view corresponding to FIG. 5A and showing a modified example in which a first take-up device and a second take-up device are provided at length direction both end sides of the belt member;

FIG. 8 is a cross-sectional view corresponding to FIG. 5A and showing a modified example in which the take-up device is disposed at a seat rear side of a side frame;

FIG. 9 is a perspective view corresponding to FIG. 1 and showing a modified example in which the belt member is disposed so as to be inclined in the direction opposite a shoulder belt portion as seen in a seat front view;

FIG. 10 is a cross-sectional view corresponding to FIG. 2 and showing a modified example in which an intermediate portion of a rear side restraining portion is structured by a front surface skin;

FIG. 11 is a cross-sectional view corresponding to FIG. 5A and showing a modified example in which a gas generator is made to be a pulling device; and

FIG. 12 is a cross-sectional view corresponding to FIG. 5A and showing a modified example in which the belt member is inserted through belt insert-through holes that are formed in left and right side frames.

### DETAILED DESCRIPTION

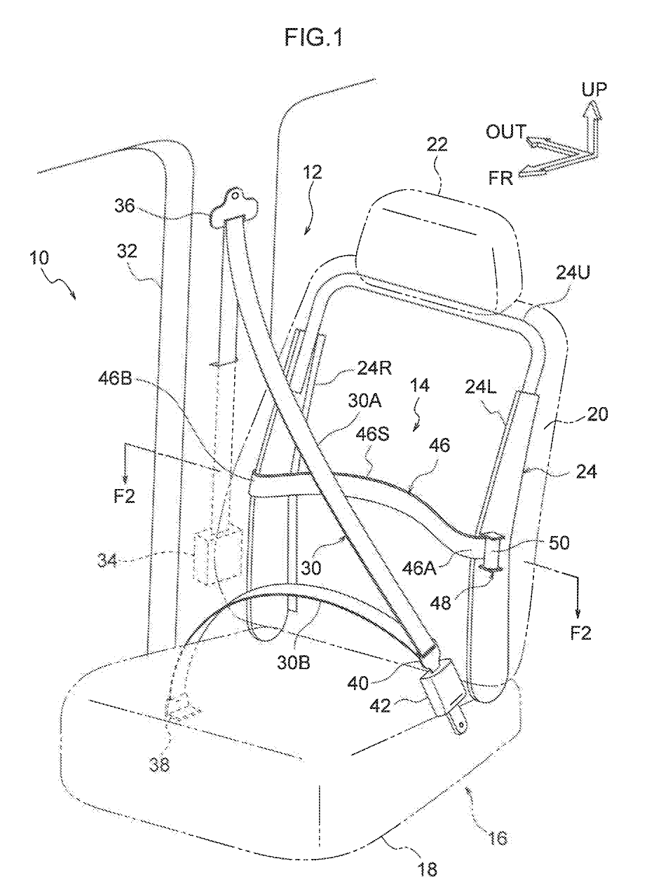

A vehicle occupant restraining device 10 relating to a preferred embodiment is described hereinafter by using FIG. 1 through FIG. 5B. Note that arrow FR, arrow UP, arrow OUT that are marked appropriately in the respective drawings indicate the forward direction (the advancing direction), the upward direction, and outwardly in the vehicle transverse direction of the vehicle, respectively. Hereinafter, when description is given by merely using longitudinal, left-right and vertical directions, they refer to the longitudinal of the vehicle longitudinal direction, the left and right of the vehicle left-right direction (the vehicle transverse direction) and the vertical of the vehicle vertical direction, unless otherwise indicated. Further, there are cases in which some of the reference numerals are omitted from the respective drawings.

(Structure)

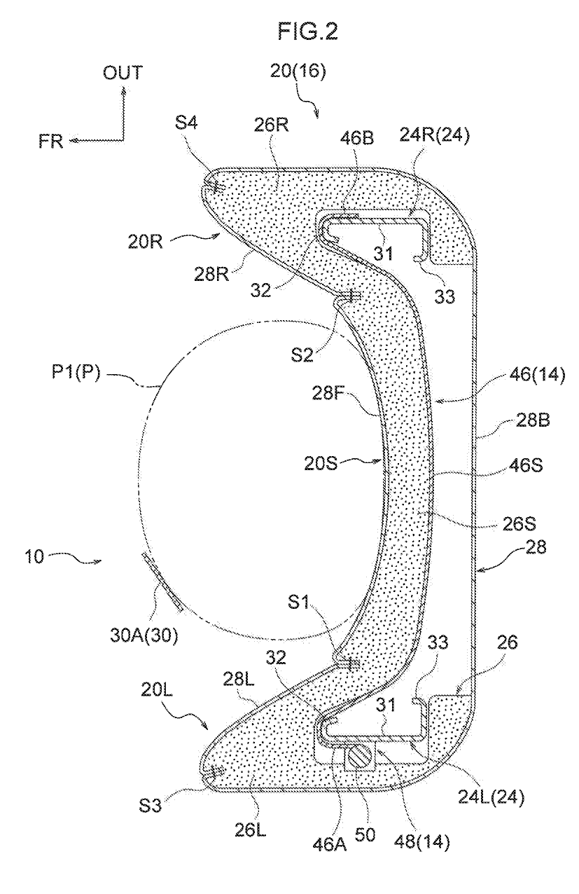

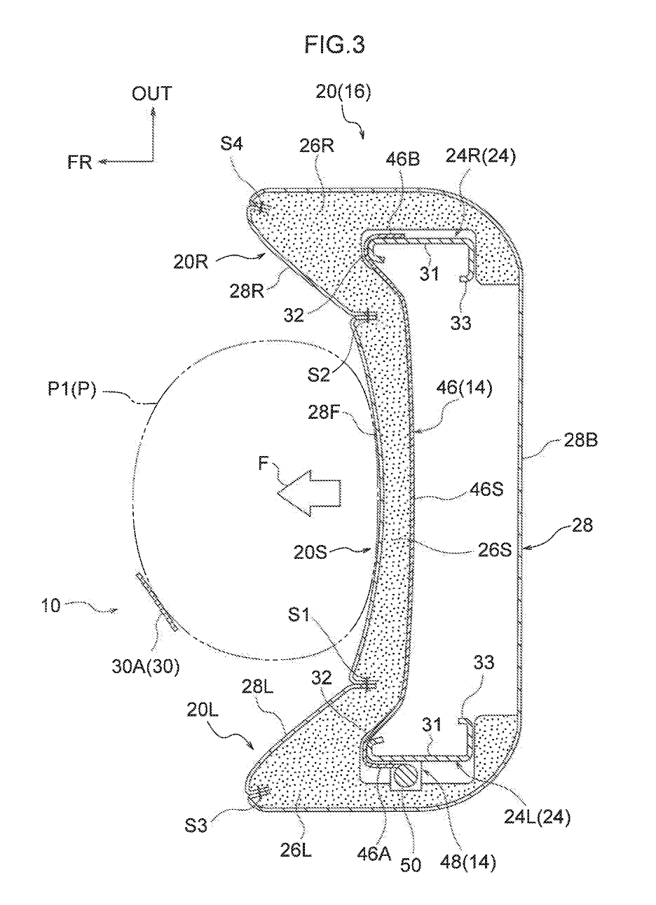

As shown in FIG. 1, the vehicle occupant restraining device 10 has a three-point seatbelt device 12 and a rear side restraining device 14. The vehicle occupant restraining device 10 is a device for restraining, at a vehicle seat 16, a vehicle occupant P (refer to FIG. 2 and FIG. 3, not illustrated in the other drawings) who is seated at the vehicle seat 16. The vehicle seat 16 has a seat cushion 18, a seatback 20 and a headrest 22, and is disposed at a vehicle transverse direction one side (here, the vehicle right side) of the vehicle cabin interior. The longitudinal, left-right, and vertical directions of the vehicle seat 16 coincide with the longitudinal, left-right and vertical directions of the vehicle. Note that, in a case in which the vehicle seat 16 is disposed at the vehicle left side of the vehicle cabin interior, the structure has left-right symmetry with respect to the present embodiment.

As shown in FIG. 2 and FIG. 3, a left-right direction central portion of the seatback 20 of the vehicle seat 16 is a main body portion 20S, and left-right direction both side portions are side support portions 20L, 20R. The left and right side support portions 20L, 20R project-out further toward a seat front side than the main body portion 20S, and are structured to support a back portion of the vehicle occupant P, who is leaning on the main body portion 20S, from seat transverse direction outer sides. In this seatback 20, a seat pad 26 that is mounted to a seatback frame 24 is covered by a seat surface skin 28.

The seatback frame 24 is formed of metal for example, and structures the frame of the seatback 20. The seatback frame 24 has a pair of left and right side frames 24L, 24R that extend in the vertical direction (the length direction) of the seatback 20 at the left and right both sides of the seatback 20. Upper end portions of the left and right side frames 24L, 24R are connected in the seat transverse direction (the seat left-right direction) by an upper frame 24U that is fanned in a substantially upside-down U-shape as seen in a seat front view. Lower end portions of the left and right side frames 24L, 24R are connected in the seat transverse direction by an unillustrated lower frame. The left and right side frames 24L, 24R each has, as seen in a plan sectional view of the seatback 20, a side wall portion 31 that extends in the seat length direction, a front flange portion 32 that extends from the front end of the side wall portion 31 toward a seat transverse direction inner side, and a rear flange portion 33 that extends from a rear end of the side wall portion 31 toward the seat transverse direction inner side.

The seat pad 26 is formed by a foamed body such as, for example, a urethane pad or the like, and structures a cushion material of the seatback 20. The seat pad 26 integrally has a pad main body portion 26S that is disposed at the main body portion 20S of the seatback 20, and left and right pad side portions 26L, 26R that are disposed at the left and right side support portions 20L, 20R. The pad main body 26S is supported from the seat rear side by unillustrated seatback springs that are mounted to the seatback frame 24, and is structured to elastically support, from the seat rear side, the back portion of the vehicle occupant P who is leaning on the seatback 20. As seen in a plan sectional view of the seatback, seat transverse direction inner sides of the left and right pad side portions 26L, 26R are open, and surround the left and right side frames 24L, 24R from the seat longitudinal direction and the seat transverse direction outer sides. These pad side portions 26L, 26R are structured to elastically support an upper half body P1 of the vehicle occupant P from the seat transverse direction both sides.

The seat surface skin 28 is formed of, for example, a cloth material, leather, synthetic leather, or the like, and structures the surface skin of the seatback 20. The seat surface skin 28 has a front surface skin 28F that covers the pad main body portion 26S from the seat front side, front side surface skins 28L, 28R that cover the pad side portions 26L, 26R from the seat front side, and a rear side surface skin 28B that covers the pad side portions 26L, 26R from the seat transverse direction outer sides and the seat rear side and covers the pad main body portion 26S from the seat rear side. The front surface skin 28F is interposed between the upper half body P1 of the vehicle occupant P and the pad main body portion 26S, and the front side surface skins 28L, 28R are interposed between the upper half body P1 of the vehicle occupant P and the pad side portions 26L, 26R. The front side surface skins 28L, 28R are sewn together with the front surface skin 28F at sewn portions S1, S2, and are sewn together with the rear side surface skin 28B at sewn portions S3, S4.

The three-point seatbelt device 12 has a seatbelt (webbing) 30. The seatbelt 30 is formed in the shape of an elongated belt of a material such as synthetic fibers or the like, and is flexible. One length direction end portion of the seatbelt 30 is anchored on a spool (a take-up shaft, not illustrated) of a seatbelt retractor 34 that is fixed to a lower end portion of a B pillar (a center pillar, the same holds hereinafter) of the vehicle. A length direction intermediate portion of the seatbelt 30 is trained around a shoulder anchor (slip joint) 36 that is mounted to an upper portion of the B pillar. Length direction another end portion of the seatbelt 30 is anchored on an anchor member 38 that is fixed to a floor (not illustrated) of the vehicle in a vicinity of the lower end portion of the B pillar.

Further, a tongue plate 40 is slidably attached to a length direction intermediate portion of the seatbelt 30, between the shoulder anchor 36 and the anchor member 38. The tongue plate 40 is connected to a buckle 42 that is provided at a vehicle transverse direction central side of the vehicle seat 16. When this tongue plate 40 is connected to the buckle 42, there is a state in which the vehicle occupant P who is seated at the vehicle seat 16 has applied the seatbelt 30 (a state in which the vehicle occupant P is restrained at the vehicle seat 16 by the seatbelt 30). In this applied state, the region of the seatbelt 30, which region is between the tongue plate 40 and the shoulder anchor 36 is a shoulder belt portion 30A that restrains the upper half body P1 of the vehicle occupant P, and the region of the seatbelt 30, which region is between the tongue plate 40 and the anchor member 38, is a lap belt portion 30B that restrains the lumbar region of the vehicle occupant P.

The aforementioned webbing retractor 34 takes-up and houses the seatbelt 30 onto a spool with the seatbelt 30 being ready to be pulled-out. The retractor 34 is accommodated at a lower end portion of an interior of the B pillar. The retractor 34 has a locking mechanism (not illustrated) that, when it is detected that the acceleration of the vehicle is greater than or equal to a given value, or that the acceleration at which the seatbelt 30 is pulled-out from the spool is greater than or equal to a given value, locks the rotation of the spool and restricts the pulling-out of the seatbelt 30. Further, the retractor 34 has a known pretensioner mechanism that is not illustrated. The pretensioner mechanism is an explosive-type pretensioner mechanism, and is structured so as to take the seatbelt 30 up forcibly onto the spool by rotating the spool by igniting an explosive at the time when a front collision of the vehicle is sensed. Note that the pretensioner mechanism is not limited to an explosive-type, and may be an electrically powered type. Further, the retractor 34 has a known pre-crash seatbelt mechanism that is not illustrated. The pre-crash seatbelt mechanism is structured so as to take the seatbelt 30 up forcibly onto the spool by rotating the spool by the driving force of a motor at the time when a front collision or a side collision of the vehicle is predicted.

The rear side restraining device 14 has a belt member 46 that serves as a rear side restraining portion, and a take-up device 48 that serves as a pulling device. The belt member 46 is formed in the shape of an elongated belt of a material that is similar to that of the seatbelt 30, and is flexible. The belt member 46 is disposed within the seatback 20 at the seat rear side of the upper half body P1 of the vehicle occupant P. The belt member 46 is disposed with a length direction thereof being the seat transverse direction, between the left and right pad side portions 26L, 26R and at a seat rear side of the pad main body portion 26S. One end portion (one length direction end portion) 46A and another end portion (another length direction end portion) 46B of the belt member 46 are supported at the left and right side frames 24L, 24R. An intermediate portion (length direction intermediate portion) 46S of the belt member 46 spans between the front end portions of the left and right side frames 24L, 24R in a slack state and convex toward the seat rear side. The intermediate portion 46S of the belt member 46 is disposed at the seat rear side of the pad main body portion 26S, and is fit tightly to a seat rear side surface of the pad main body portion 26S, and is disposed between the pad main body portion 26S and the unillustrated seatback springs. Note that the aforementioned “slack state” has the same meaning as “curved state” and “state of having surplus length”.

In the present embodiment, the one end portion 46A and the other end portion 46B of the belt member 46 are disposed at a same height in the vertical direction of the seatback 20. Further, in a case in which, for example, the vehicle occupant P who is seated at the vehicle seat 16 has a physique that is equivalent to that of an AM50 (50th percentile U.S. adult male) dummy, the belt member 46 is disposed so as to be positioned slightly further toward an upper side than the solar plexus of the vehicle occupant P who corresponds to an AM50. Further, as seen in a seat front view, the belt member 46 is disposed so as to intersect the shoulder belt portion 30A in a vicinity of a left-right direction central portion of a vehicle occupant P who corresponds to an AM50.

An other end portion 46B side of the belt member 46 is trained from a seat front side around the front end portion of the side frame 24R that is disposed at the vehicle transverse direction outer side. The other end portion 46B of the belt member 46 is anchored on the side wall portion 31 of the side frame 24R. It is preferable to use a method in which the other end portion 46B of the belt member 46 can be anchored securely on the side frame 24R. For example, in the same way as the length direction other end portion of the seatbelt 30 being anchored on the floor of the vehicle via the anchor member 38, there may be a structure in which the other end portion 46B of the belt member 46 is anchored on the side frame 24R via an anchor member.

A one end portion 46A side of the belt member 46 is trained from a seat front side around the front end portion of the side frame 24L that is disposed at the vehicle transverse direction inner side. The one end portion 46A of the belt member 46 extends toward a vehicle transverse direction inner side with respect to the side frame 24L. The take-up device 48 is disposed at the vehicle transverse direction inner side of the side frame 24L. Note that the take-up device 48 is illustrated schematically in FIG. 2 and FIG. 3.

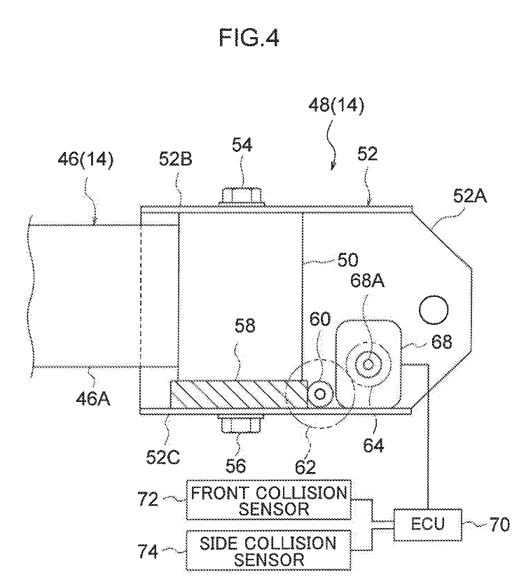

An example of the take-up device 48 is illustrated in FIG. 4. The take-up device 48 has a take-up shaft 50 on which the one end portion 46A of the belt member 46 is anchored, and a frame 52 that supports the take-up shaft 50 rotatably. Note that, for example, a method that is similar to a method of anchoring a seatbelt on the spool of a general seatbelt retractor can be employed as the method of anchoring the one end portion 46A of the belt member 46 on the take-up shaft 50.

The frame 52 has a back plate 52A that is formed in the shape of a plate whose plate thickness direction is the seat transverse direction. The back plate 52A is fixed to the side wall portion 31 of the side frame 24L by means such as fastening by bolts or the like. A pair of leg pieces 52B, 52C extend-out substantially orthogonally from the upper and lower both end portions of the back plate 52A toward the seat transverse direction outer side. Due thereto, the frame 52 is formed in a substantial U-shape that opens toward the seat transverse direction outer side as seen in a seat front view.

The take-up shaft 50 is formed in the shape of a solid cylinder, and is disposed between the leg pieces 52B, 52C with an axial direction thereof being the direction in which the leg pieces 52B, 52C face one another (the vertical direction of the seatback 20). Stepped bolts 54, 56 that pass-through the leg pieces 52B, 52C are screwed together with the axial direction both end portions of the take-up shaft 50. Due thereto, the take-up shaft 50 is rotatably supported by the leg pieces 52B, 52C via the stepped bolts 54, 56. A worm wheel 58 is disposed between the one leg piece 52C and the take-up shaft 50. The worm wheel 58 is provided coaxially and integrally with the take-up shaft 50, and the aforementioned stepped bolt 56 passes-through an axially central portion of the worm wheel 58.

A worm gear 60 is screwed together with the worm wheel 58. The worm gear 60 is disposed with the axial direction thereof being the seat transverse direction. The axial direction both end portions of the worm gear 60 are rotatably supported by the frame 52 and by unillustrated brackets that are fixed to the frame 52. A spur gear 62 is fixed coaxially to an axial direction one end portion of the worm gear 60, and another spur gear 64 is meshed-together with this spur gear 62. The spur gear 64 is fixed coaxially to an output shaft 68A of a motor 68 that is fixed to the leg piece 52C of the frame 52. Due thereto, there is a structure in which the rotation of the output shaft 68A of the motor 68 is transmitted to the worm wheel 58 via the spur gears 64, 62 and the worm gear 60, and the worm wheel 58 is rotated integrally with the take-up shaft 50. Note that this is a structure in which, at usual times, rotation of the take-up shaft 50 is prevented by self-locking of the worm wheel 58 due to the meshing together with the worm gear 60.

As shown in FIG. 4, an ECU (Electronic Control Unit) 70 is electrically connected to the motor 68. A front collision sensor 72 and a side collision sensor 74 are electrically connected to the ECU 70. The front collision sensor 72 is structured to include, for example, acceleration sensors that are disposed at front side members or the like, acceleration sensors that are disposed at the vehicle transverse direction outer side end portions of the front bumper reinforcement, an acceleration sensor that is disposed at the floor of the vehicle, or the like, and detects a front collision of the vehicle. A front collision includes, in addition to a head-on collision (a full-overlap front collision), an asymmetrical collision such as an oblique collision or a small overlap collision or the like. The side collision sensor 74 is structured to include, for example, pressure sensors or acceleration sensors (in-door sensors) that are disposed within front side doors and rear side doors, and acceleration sensors (in-pillar sensors) that are disposed within the B pillars, and is structured to detect a side collision of the vehicle.

In further detail, the aforementioned oblique collision (an MDB oblique collision) is a collision from an obliquely front side that is prescribed by NHTSA for example (as an example, a collision in which an relative angle of the own vehicle with the other object involved in the collision is 15°, and the amount of overlap of the own vehicle and the other object in a vehicle transverse direction is around 35%). In this embodiment, as an example, an oblique collision at a relative speed of 90 km/hr is assumed. Further, the aforementioned small overlap collision is a collision in which, among front collisions of a vehicle, for example, an amount of overlap of the own vehicle in the vehicle transverse direction with the other object involved in the collision as prescribed by IIHS is less than or equal to 25%. For example, a collision toward a vehicle transverse direction outer side of a front side member that is the vehicle body frame corresponds to a small overlap collision. In this embodiment, as an example, a small overlap collision at a relative speed of 64 km/hr is assumed. Note that IIHS is the abbreviation for the Insurance Institute for Highway Safety of the U.S., and NHTSA is the abbreviation for the National Highway Traffic Safety Administration of the U.S.

The ECU 70 is structured so as to operate the motor 68 at the time when the ECU 70 senses a side collision on the basis of the output of the side collision sensor 74, and at the time when the ECU 70 senses an asymmetrical collision on the basis of output of the front collision sensor 72. Note that the pretensioner mechanism that the above-described retractor 34 has is structured so as to be operated at the time when a front collision is detected by the front collision sensor 72, but there may be a structure in which the above-described pretensioner mechanism is operated also at the time when a side collision is detected by the side collision sensor 74. Further, in a case in which a collision predicting sensor for predicting (forecasting) a collision of the vehicle is electrically connected to the ECU 70, there may be a structure in which the ECU 70 operates the motor 68 at the time of predicting a side collision or an asymmetrical collision on the basis of the output of the collision predicting sensor. In this case, it is preferable to operate the motor of the precrash seatbelt mechanism that the retractor 34 has, simultaneously or substantially simultaneously with the motor 68. For example, at least one of millimeter wave radar, a stereo camera and an infrared laser that can monitor the front and the sides of the vehicle can be applied as the aforementioned collision predicting sensor.

(Operation and Effects)

Operation and effects of the present embodiment are described next.

In the vehicle occupant restraining device 10 of the above-described structure, the vehicle occupant P who is seated at the vehicle seat 16 is restrained by the shoulder belt portion 30A and the lap belt portion 30B of the seatbelt 30. The belt member 46 is disposed at the seatback 20 of the vehicle seat 16 at the side of the upper half body P1 of the vehicle occupant P which side is opposite from the side at which the shoulder belt portion 30A is located. The intermediate portion 46S of the belt member 46 spans between the left and right side frames 24L, 24R of the seatback 20, in a slack state and convex toward the seat rear side. Further, the one end portion 46A of the belt member 46 is anchored on the take-up shaft 50 of the take-up device 48 that is fixed to the one side frame 24L, and the other end portion 46B of the belt member 46 is anchored on the other side frame 24R.

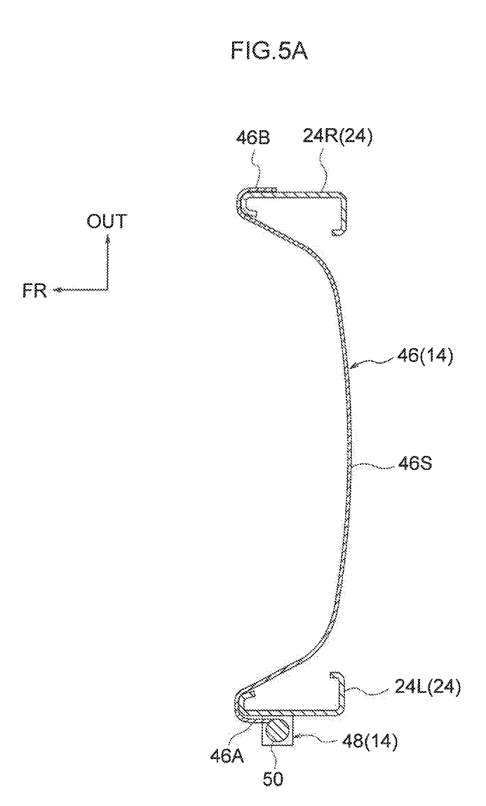

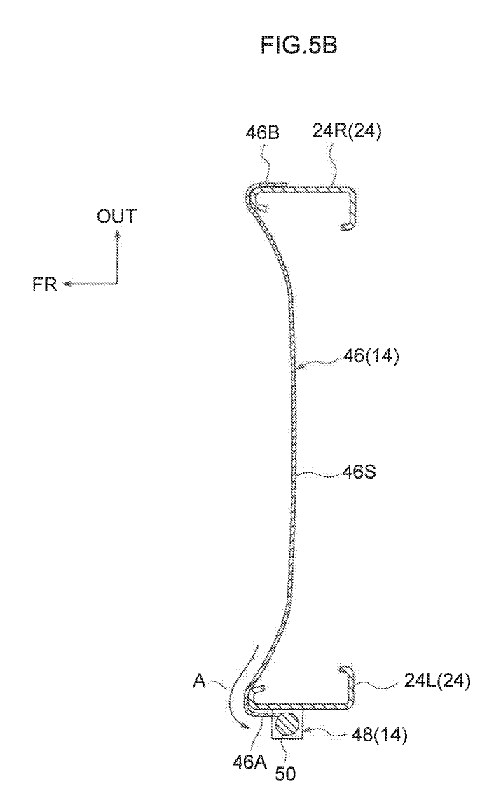

Here, when the vehicle is involved in a side collision or an asymmetrical collision, pulling-out of the seatbelt 30 from the retractor 34 is prevented by the locking mechanism of the retractor 34. Further, on the basis of the output of the side collision sensor 74 or the front collision sensor 72, the ECU 70 senses a side collision or an asymmetrical collision, and operates the motor 68 of the take-up device 48. Due thereto, the take-up shaft 50 of the take-up device 48 rotates, and the one end portion 46A side of the belt member 46 is taken-up onto the take-up shaft 50 and pulled (refer to arrow A in FIG. 5B). As a result, the slack of the intermediate portion 46S of the belt member 46, which was convex toward the seat rear side and slack as shown in FIG. 2 and FIG. 5A, is reduced as shown in FIG. 3 and FIG. 5B, and the belt member 46 is stretched in a rectilinear form or a substantially rectilinear form between the front end portions of the left and right side frames 24L, 24R.

When the belt member 46 is stretched as described above, due to the pad main body portion 26S and the front face skin 28F being pushed toward the seat front side (the vehicle front side) by the belt member 46, the upper half body P1 of the vehicle occupant P is pushed-out toward the vehicle front side (the shoulder belt portion 30A side) (refer to arrow F in FIG. 3). As a result, the upper half body P1 of the vehicle occupant P is nipped and restrained from the front and rear both sides by the shoulder belt portion 30A and the belt member 46. Due thereto, the frictional forces that are applied between the seatback 20 and the upper half body P1 and between the shoulder belt portion 30A and the upper half body P1 increase, and therefore, sideways movement of the upper half body P1 with respect to the seatback 20 (the vehicle seat 16) can be suppressed effectively. In particular, at the time of an asymmetrical collision of the vehicle, due to the pretensioner mechanism of the retractor 34 being operated and the seatbelt 30 being taken-up onto the spool of the retractor 34, the slack of the shoulder belt portion 30A is eliminated. Due thereto, the force of restraining the vehicle occupant P from the front and rear both sides by the shoulder belt portion 30A and the belt member 46 increases effectively, and therefore, sideways movement of the upper half body P1 with respect to the vehicle seat 16 can be suppressed effectively. Note that effects that are similar to those described above are obtained in a case in which the pretensioner mechanism of the retractor 34 is structured so as to be operated also at the time of a side collision of the vehicle.

Moreover, the above-described belt member 46 spans between the front end portions of the left and right side frames 24L, 24R of the seatback 20, and restrains the vehicle occupant P while receiving reaction force from the left and right side frames 24L, 24R. Therefore, there is no need for a special reaction force member for applying reaction force to the belt member 46. Due thereto, the structure can be simplified.

Further, as described above, sideways movement of the upper half body P1 of the vehicle occupant P with respect to the vehicle seat 16 is suppressed. Therefore, in a case in which a side airbag device is installed in the side support portion 20R (see FIG. 2 and FIG. 3) of the seatback 20, the space for expansion of the side airbag is ensured, and the expansion performance of the side airbag improves. Moreover, this contributes as well to preventing the vehicle occupant P who is seated at the vehicle seat 16, and a vehicle occupant who is seated in another vehicle seat that is positioned at the side of the vehicle seat 16, from colliding with one another.

Further, in the present embodiment, the take-up device 48 (the pulling device) is structured so as to pull the one end portion 46A side of the belt member 46 while taking the one end portion side 46A onto the take-up shaft 50. Due thereto, the space for placement of the pulling device can be reduced as compared with a structure in which the pulling device rectilinearly pulls the one end portion 46A side of the belt member 46. Moreover, because the take-up device 48 is structured so as to rotate the take-up shaft 50 by the motor 68, the belt member 46 can be made to go slack again by rotating the motor 68 reversely after a collision. Due thereto, the rear side restraining device 14 can be used repeatedly. Accordingly, there is no need to replace parts after a collision, and repair costs are inexpensive. Note that, for example, in a structure in which an airbag is inflated by an inflator such as in the case of the vehicle occupant protecting device described in the Related Art section, there is the need to replace the inflator and the like after a collision, and therefore, there is the possibility that the repair costs will be high. However, this can be avoided in the present embodiment.

Moreover, in the present embodiment, the belt member 46 is disposed within the seatback 20, and the belt member 46 cannot be seen from the outer side of the vehicle seat 16. Therefore, the design of the vehicle seat 16 does not deteriorate. Further, because the belt member 46 is formed of a material that is similar to the seatbelt 30, the belt member 46 can be made to be a simple structure. Moreover, the intermediate portion 46S of the belt member 46 is disposed at the seat rear side of the pad main body portion 26S that supports the back portion of the vehicle occupant P from the seat rear side. Therefore, at usual times, the vehicle occupant P receiving an uncomfortable sensation from the belt main body 46 can be prevented or suppressed effectively.

(Modified Examples)

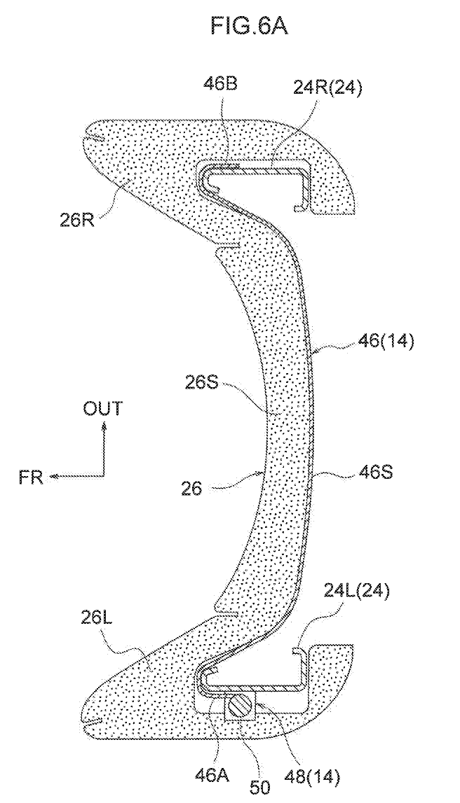

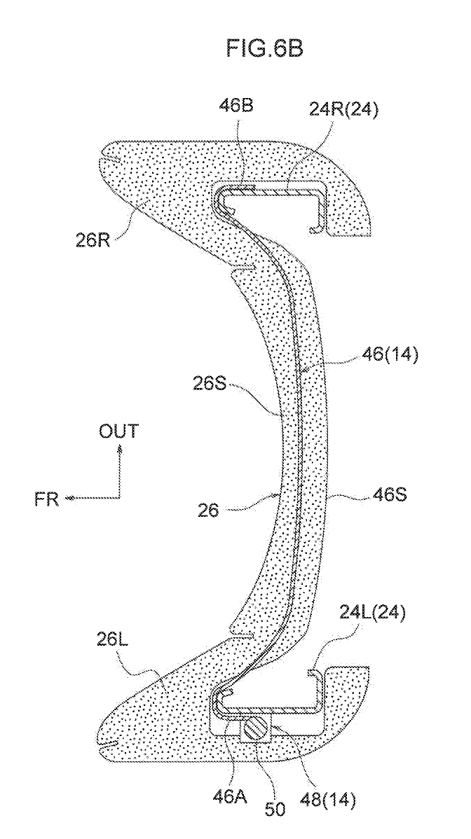

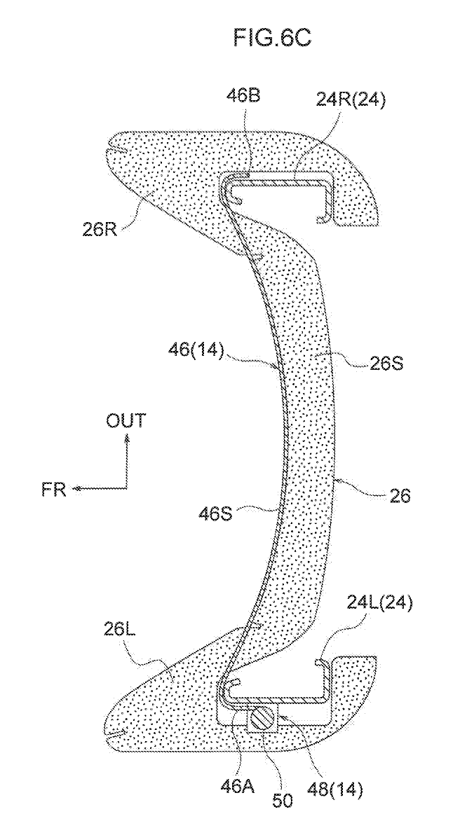

Various modified examples of the above-described embodiment are described hereinafter by using FIG. 6A through FIG. 12. Note that FIG. 6A illustrates the structure of the above-described embodiment, and is a drawing for facilitating comparison with FIG. 6B and FIG. 6C. Further, in FIG. 6B through FIG. 12 and in the following description, structures and operation that are basically similar to those of the above-described embodiment are denoted by the same reference numerals as in the above-described embodiment, and description thereof is omitted.

In the above-described embodiment, there is a structure in which the intermediate portion 46S of the belt member 46 is disposed at the seat rear side of the pad main body portion 26S (refer to FIG. 2, FIG. 3 and FIG. 6A), but the present invention is not limited to this. Namely, as in a first modified example that is shown in FIG. 6B, there may be a structure in which the intermediate portion 46S of the belt member 46 is embedded in the pad main body portion 26S. Further, as in a second modified example that is shown in FIG. 6C, there may be a structure in which the intermediate portion 46S of the belt member 46 is disposed at the seat front side of the pad main body portion 26S.

In the second modified example that is shown in FIG. 6C, the intermediate portion 46S of the belt member 46 is disposed between the front surface skin 28F (not illustrated in FIG. 6C) of the seat surface skin 28 and the pad main body portion 26S. In this second modified example, because the intermediate portion of the belt member 46 is disposed at the seat front side of the pad main body portion 26S, the pad main body portion 26S is not interposed between the upper half body P1 of the vehicle occupant P (not illustrated in FIG. 6C) and the intermediate portion 46S of the belt member 46. Due thereto, the restraining force, at the time when the slack of the belt member 46 is reduced and the upper half body P1 of the vehicle occupant P is restrained, increases as compared with a case in which the pad main body portion 26S is interposed between the upper half body P1 of the vehicle occupant P and the intermediate portion 46S of the belt member 46 (see FIG. 6A).

Further, in the first modified example shown in FIG. 6B, the intermediate portion 46S of the belt member 46 is embedded in the pad main body portion 26S by integral foam molding with the seat pad 26. In this first modified example, the uncomfortable sensation that the vehicle occupant P receives from the belt member 46 at usual times can be reduced more than in the above-described second modified example (see FIG. 6C), while the restraining force, at the time when the slack of the belt member 46 is reduced and the upper half body P1 of the vehicle occupant P is restrained, is increased more than in the above-described embodiment (see FIG. 6A).

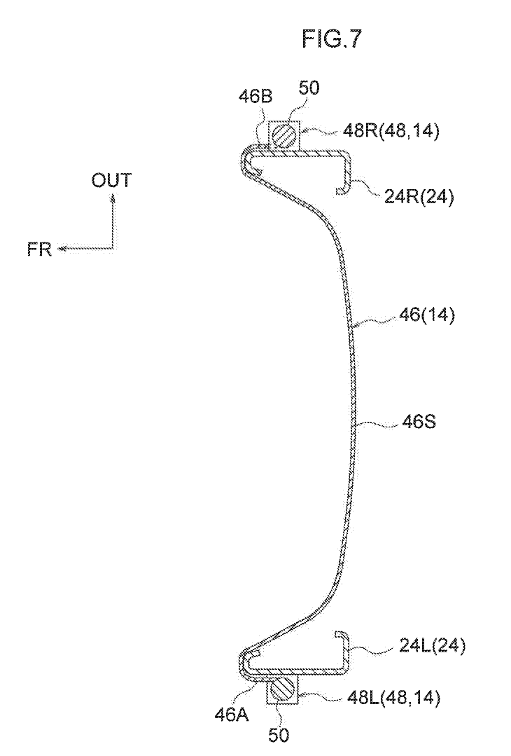

Further, the above-described embodiment is structured such that only the one end portion 46A side of the belt member 46 is taken-up (pulled) by the take-up device 48, but the present invention is not limited to this and may be structured as the third modified example that is shown in FIG. 7. In this third modified example, the one end portion 46A of the belt member 46 is anchored on the take-up shaft 50 of a first take-up device 48L that is fixed to the one side frame 24L, and the other end portion 468 of the belt member 46 is anchored on the take-up shaft 50 of a second take-up device 48R that is fixed to the other side frame 24R. The take-up device 48 is structured by the first take-up device 48L and the second take-up device 48R. Further, at the time when a side collision or an asymmetrical collision of the vehicle is sensed, the first take-up device 48L takes-up the belt member 46 from the one end portion 46A side, and the second take-up device 48R takes-up the belt member 46 from the other end portion 46B side. Due thereto, the slack of the belt member 46 can be reduced rapidly.

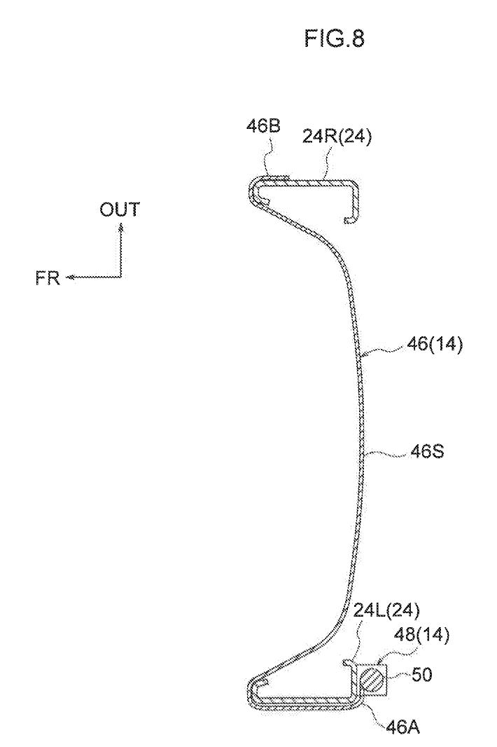

Further, the above-described embodiment is structured such that the take-up device 48 is disposed at the vehicle transverse direction inner side of the side frame 24L, but the present invention is not limited to this. As in a fourth modified example that is shown in FIG. 8, there may be a structure in which the take-up device 48 is disposed at a vehicle rear side (the seat rear side) of the side frame 24L.

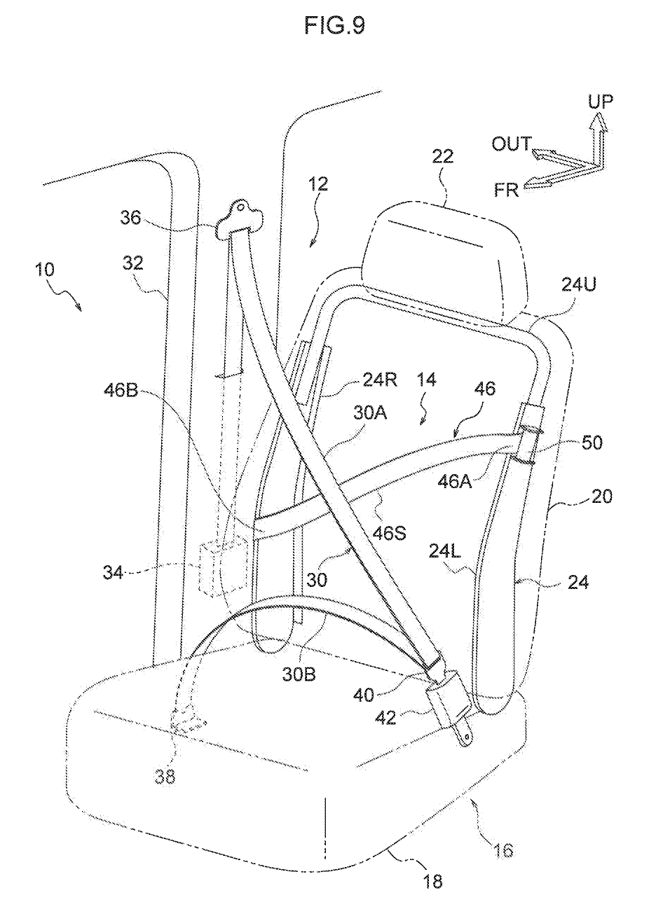

Further, the above-described embodiment is structured such that the one end portion 46A and the other end portion 46B of the belt member 46 are disposed at the same height in the vertical direction of the seatback 20. However, the present invention is not limited to this, and may be structured such that the one end portion 46A and the other end portion 46B of the belt member 46 are disposed at different heights in the vertical direction of the seatback 20. For example, in a fifth modified example that is shown in FIG. 9, the one end portion 46A of the belt member 46 is disposed further toward an upper side of the seatback 20 than the other end portion 46B. In this fifth modified example, the belt member 46 is disposed so as to be inclined in a direction opposite the shoulder belt portion 30A as seen in a seat front view. Due thereto, the belt member 46 and the shoulder belt portion 30A cross one another in the shape of an X as seen in a seat front view. Therefore, the upper half body P1 of the vehicle occupant P can be restrained in a well-balanced manner at the left and the right by the belt member 46 and the shoulder belt portion 30A.

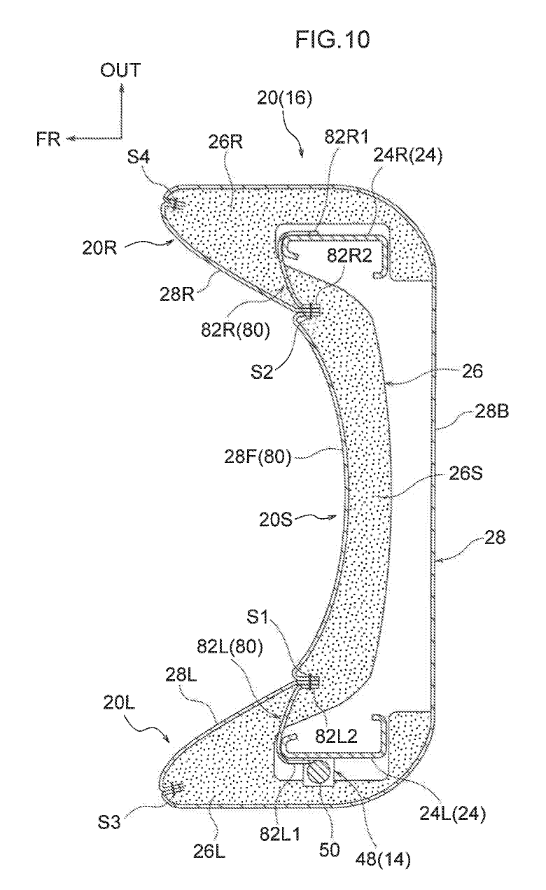

Further, although the present embodiment is structured such that the belt member 46 that is formed in an elongated shape is made to be the rear side restraining portion, the present invention is not limited to this, and may be structured such as the sixth modified example that is shown in FIG. 10. In this sixth modified example, a rear side restraining portion 80 is structured by the front surface skin 28F and a pair of left and right straps 82L, 82R. The front surface skin 28F structures the intermediate portion of the rear side restraining portion 80, and the left and right straps 82L, 82R structure one end side and another end side of the rear side restraining portion 80. These straps 82L, 82R are formed in the shapes of elongated belts of, for example, a material that is similar to that of the belt member 46 relating to the above-described embodiment, but are formed to be shorter than the belt member 46.

A one end portion 82L1 of the one strap 82L is anchored to the take-up shaft 50 of the take-up device 48, and another end portion 82L2 is sewn together with the front surface skin 28F and the front side surface skin 28L at the sewn portion S1. One end portion 82R1 of the other strap 82R is anchored to the side frame 24R, and the other end portion 82R2 is sewn together with the front surface skin 28F and the front side surface skin 28R at the sewn portion S2. Due thereto, the rear side restraining portion 80, which is formed by the front surface skin 28F and the pair of left and right straps 821, 82R, spans between the left and right side frames 24L, 24R in a slack state and convex toward the seat rear side.

In this sixth modified example, when the take-up shaft 50 of the take-up device 48 rotates, the strap 82L is taken-up onto the take-up shaft 50 from the one end portion 82L1 side, and, due thereto, the rear side restraining portion 80 is pulled and stretched by the take-up device 48. Due thereto, in the same way as in the above-described embodiment, the upper half body P1 of the vehicle occupant P is pushed-out toward the vehicle front side (the shoulder belt portion 30A side). As a result, the upper half body P1 of the vehicle occupant P is nipped and restrained from the front and rear both sides by the shoulder belt portion 30A and the rear side restraining portion 80, and therefore, sideways movement of the upper half body P1 with respect to the vehicle seat 16 (the seatback 20) can be suppressed effectively. Moreover, in this sixth modified example, the structure of the device can be simplified because the intermediate portion of the rear side restraining portion 80 is structured by the front surface skin 28F.

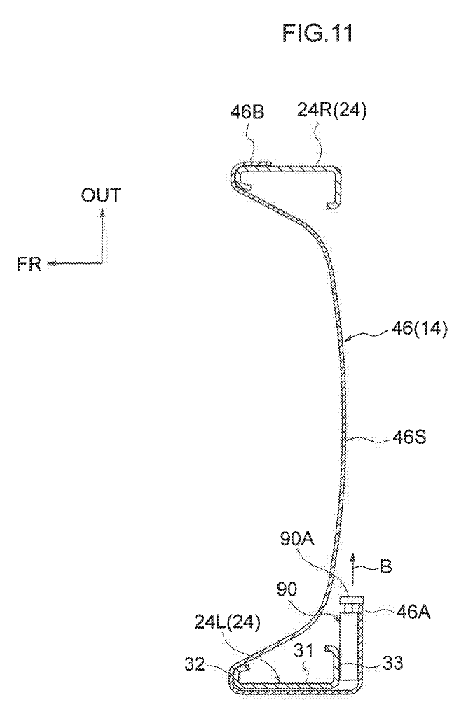

Further, although the above-described embodiment is structured such that the take-up device 48 is the pulling device, the present invention is not limited to this. It suffices for the pulling device to be a device that is able to reduce slack of the rear side restraining portion by pulling at least one end portion side of the rear side restraining portion, and the structure thereof can be changed appropriately. For example, as in a seventh modified example that is shown in FIG. 11, there may be a structure in which a gas generator 90 is made to be the pulling device. This gas generator 90 is fixed to the rear flange portion 33 of the side frame 24L in a posture that is such that the distal end portion of a rod 90A faces toward the seat transverse direction inner side. The one end portion 46A of the belt member 46 is anchored on the distal end portion of the rod 90A. This is a structure in which, due to the gas generator 90 operating by an operation signal from the ECU 70 (not illustrated in FIG. 11), the gas generator 90 causes the rod 90A to protrude-out toward the seat transverse direction inner side (refer to arrow B in FIG. 11). Due thereto, the one end portion 46A of the belt member 46 is pulled toward the seat transverse direction inner side, and slack of the intermediate portion 46S of the belt member 46 is reduced. In this seventh modified example as well, in the same way as in the above-described embodiment, sideways movement of the upper half body P1 of the vehicle occupant P with respect to the seatback 20 can be suppressed.

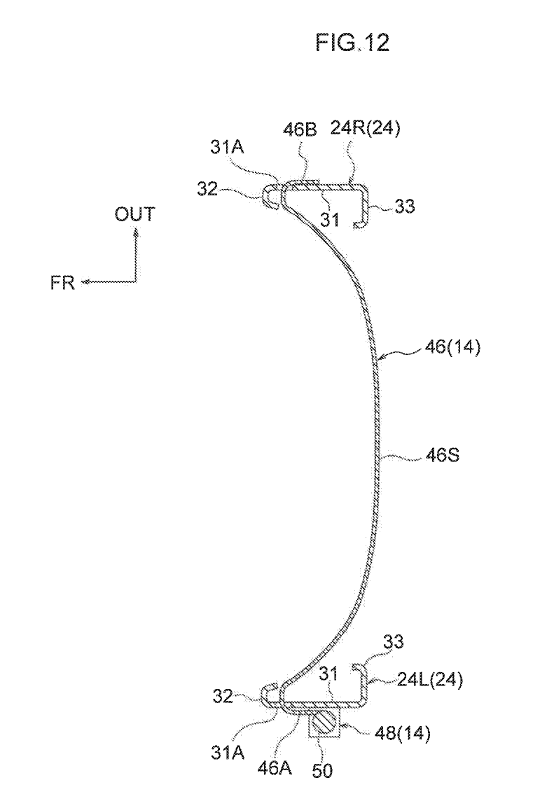

Further, the above-described embodiment is structured such that the belt member 46 spans between the front end portions of the left and right side frames 24L, 24R, but the present invention is not limited to this and may be structured such as an eighth modified example that is shown in FIG. 12. In this eighth modified example, insert-through holes 31A through which the belt member 46 is inserted are formed in front portions of the side wall portions 31 of the left and right side frames 24L, 24R. In this eighth modified example as well, operation and effects that are basically similar to those of the above-described embodiment are obtained. Note that, although not illustrated, there may be a structure in which the take-up device 48 is fixed to the seat transverse direction inner side surface of the side wall portion 31 of the side frame 24L, and the other end portion 46B of the belt member 46 is anchored on a seat transverse direction inner side surface of the side wall portion 31 of the side frame 24R.

Further, although the above-described embodiment is structured such that the take-up device 48 is a motorized-type (an electrically powered type) device that rotates the take-up shaft 50 by the motor 68, the present invention is not limited to this. For example, although not illustrated, there may be a structure in which the take-up device is an explosive-type device. In this case, there is a structure in which the take-up shaft is rotated by a mechanism that is similar to the explosive-type pretensioner mechanism of the seatbelt retractor. In a case in which the take-up device is an explosive-type device, slack of the rear side restraining portion can be reduced rapidly.

Further, although the above-described embodiment is structured such that the seatback 20 has the seat pad 26 and the seat surface skin 28, the present invention is not limited to this. For example, although not illustrated, the seatback may be structured so as to support the back portion of the vehicle occupant by a net-like member that is supported at the seatback frame. In this case, the net-like member may be made to be the rear side restraining portion, or a belt member may be disposed at a seat front side or a seat rear side of the net-like member.

Moreover, the above-described embodiment is structured such that the belt member 46 is disposed between the pad main body portion 26S and the unillustrated seatback springs, but the present invention is not limited to this and may be structured such that the belt member 46 is disposed at a seat rear side of the seatback springs. In this case, there is a structure in which the seatback springs are pushed-out toward the seat front side due to slack of the intermediate portion 46S of the belt member 46 being reduced.

In addition, the present invention can be implemented by being modified in various ways within a scope that does not depart from the scope of the claims. Further, the scope of the present invention is, of course, not to be limited by the above-described embodiment and above-described modified examples.

What is claimed is:

1. A vehicle occupant restraining device comprising:
a three-point seatbelt device adapted to restrain a vehicle occupant, who is seated at a vehicle seat, by a shoulder belt portion and a lap belt portion of a seatbelt;
a rear side restraining portion configured to be disposed at a seatback of the vehicle seat, and spanning between left and right side frames of the seatback, the rear side restraining portion being in a slack state and convex toward a seat rear side; and
a pulling device that, by pulling at least one end portion side of the rear side restraining portion, reduces slack of the rear side restraining portion.

2. The vehicle occupant restraining device of claim 1, wherein the pulling device is a take-up device that pulls at least the one end portion side of the rear side restraining portion while taking-up at least the one end portion side onto a take-up shaft.

3. The vehicle occupant restraining device of claim 1, further comprising a vehicle seat,
wherein the rear side restraining portion is a belt member that is formed in an elongated shape and the belt member is disposed at an interior of the seatback of the vehicle seat.

4. The vehicle occupant restraining device of claim 3, wherein
the seatback has a seat pad that includes a pad main body portion that is adapted to support a back portion of the vehicle occupant from the seat rear side, and
an intermediate portion of the belt member is disposed at a seat rear side of the pad main body portion.

5. The vehicle occupant restraining device of claim 3, wherein
the seatback has a seat pad that includes a pad main body portion that is adapted to support a back portion of the vehicle occupant from the seat rear side, and
an intermediate portion of the belt member is disposed at a seat front side of the pad main body portion.

6. The vehicle occupant restraining device of claim 3, wherein
the seatback has a seat pad that includes a pad main body portion that is adapted to support a back portion of the vehicle occupant from the seat rear side, and
an intermediate portion of the belt member is embedded in the pad main body portion.

7. The vehicle occupant restraining device of claim 3, wherein
the seatback has a seat pad that includes a pad main body portion that is adapted to support a back portion of the vehicle occupant from the seat rear side, and a seat surface skin that includes a front surface skin that covers the pad main body portion from a seat front side, and
an intermediate portion of the rear side restraining portion is structured by the front surface skin.

8. The vehicle occupant restraining device of claim 3, wherein the belt member is disposed so as to be tilted in a direction opposite to a direction in which direction the shoulder belt portion is extended as seen in a seat front view.
